(19) United States
(12) Patent Application Publication
(10) Pub. No.: US 2016/0048544 A1
(43) Pub. Date: Feb. 18, 2016

(54) SYSTEM AND METHOD FOR HIERARCHICAL CATEGORIZATION OF COLLABORATIVE TAGGING

(71) Applicants: Winder Hughes, Ponte Vedra, FL (US); Will Koffel, Sudbury, MA (US); Josh Hoye, Jacksonville Beach, FL (US); Gregory Cesnik, Franklin, TN (US)

(72) Inventors: Winder Hughes, Ponte Vedra, FL (US); Will Koffel, Sudbury, MA (US); Josh Hoye, Jacksonville Beach, FL (US); Gregory Cesnik, Franklin, TN (US)

(73) Assignee: LIFE IN HI-FI, INC., Ponte Vedra, FL (US)

(21) Appl. No.: 14/826,059

(22) Filed: Aug. 13, 2015

Related U.S. Application Data
(60) Provisional application No. 62/036,882, filed on Aug. 13, 2014.

(51) Int. Cl. G06F 17/30; H04L 29/08

(52) U.S. Cl. CPC G06F 17/30336; H04L 67/02; G06F 17/30598; G06F 17/30882

(57) ABSTRACT

Systems and methods for hierarchically categorizing collaborative indexing tags includes, in one aspect, receiving data (e.g., metadata) relating to a post, including a user-selected first category identifier, and a user-defined second category identifier, and content. The systems and methods further include correlating, or mapping, the user-selected first category identifier with a first category identifier database, correlating the user-defined second category identifier with a second category identifier database, and populating a data structure with such information for storage and later retrieval.

### CROSS-REFERENCE TO RELATED APPLICATIONS

This Application is a non-provisional application for utility patent, which claims the benefit of priority under 35 U.S.C. §119(e) to U.S. Provisional Patent Application No. 62/036,882 filed Aug. 13, 2014, which application is incorporated herein by reference in its entirety.

### FIELD OF THE INVENTION

The present invention relates in general to indexing techniques, and more particularly to computer and internet-based indexing techniques, of computer and/or internet-based content, including social media and social bookmarking.

### NOTICE

A portion of the disclosure of this patent document contains material which is subject to copyright and/or other intellectual property protection. The respective owner(s) of such intellectual property have no objection to the facsimile reproduction by anyone of the patent document or the patent disclosure, as it appears in the Patent and Trademark Office patent file or records, but otherwise reserve(s) all rights whatsoever.

### BACKGROUND OF THE INVENTION

Current collaborative tagging systems (a.k.a. social classification, folksonomies) use tags (e.g., “hashtags”) to loosely categorize content, allowing users to freely create relevant categories for their purpose, this unstructured taxonomy has significant drawbacks, including difficulties in use stemming from indexing inconsistencies due to the particular linguistic confusing tag homonyms and homographs (e.g., “#orange” could refer either to the color or the fruit, and “#paris” could refer either to the place or the celebrity), as well as synonyms rooted in one or multiple written languages (multiple tags for the same concept, e.g., “#hazelnut” and “#filbert”), or inflections between plural and singular (e.g., “#apple” and “#apples”); noisy content channels, where following a content creator subjects followers to content that may not fit their interests; cluttered search results for generic terms, like “#carve”, which otherwise have specific meaning among certain groups of users; and slow emergence of tagging conventions due to competing or conflicting uses of tags by diverse cohorts of content creators (e.g., the general population).

### SUMMARY OF THE INVENTION

In accordance with the present invention, in one aspect, a method of hierarchically categorizing collaborative indexing tags, including the step of receiving first data (e.g., metadata) relating to a first post object. The first data can include a user-selected first category identifier, which can be selected from a group of predetermined identifiers, for example, and a user-defined second category identifier; and a first content object. In accordance with this aspect of the invention, the method also includes receiving a request to publish the first post object, assigning a first unique identifier to the first post object, correlating the user-selected first category identifier with a first category identifier database, correlating the user-defined second category identifier with a second category identifier database, and populating a first data structure (e.g. hash table) with the user-selected first category identifier, the user-defined second category identifier, and the first unique identifier of the first post object for storage and later retrieval.

In accordance with this aspect, if desired, the first content object can include a user-defined third category identifier, which is parsed from first content object, the method further comprising the steps of correlating the user-defined third category identifier with the second category identifier database and populating the first data structure additionally with the user-defined third category identifier of the first post object, for storage and later retrieval. Additionally, the first content object can further include a user-defined fourth category identifier, which is parsed from first content object, the method further comprising the steps of correlating the user-defined fourth category identifier with the second category identifier database, and populating the first data structure additionally with the user-defined fourth category identifier of the first post object, for storage and later retrieval.

If desired, the above method(s) can include the step of populating a second data structure, the second data structure correlating one or more user-selected first category identifiers with one or more user-defined second category identifiers, when said first and second category identifiers have been used in connection with the same post object.

If desired, in accordance with this aspect of the invention, the first content object can further include at least one hyperlink.

In accordance with a further aspect of the invention, an apparatus for hierarchically categorizing collaborative indexing tags, the apparatus including a processor and a memory coupled to the processor, wherein the memory comprises instructions which, when executed by the processor, cause the processor to carry out the above-described steps.

In accordance with still a further aspect of the invention, computer program product is provided having a non-transitory computer readable medium having a computer readable program stored therein, wherein the computer readable program, when executed on a computing device, causes the computing device to carry out the above-described steps.

### BRIEF DESCRIPTION OF THE DRAWINGS

The accompanying drawings illustrate various non-limiting, example, innovative aspects in accordance with the present descriptions:

FIG. 1 shows the first step in content creation in accordance with one aspect of the present invention.

FIG. 2 shows a suggested list of Tagtopics^{SM} identifiers these are already created Tagtopics^{SM} identifiers that the user follows and uses frequently.

FIG. 3 shows a post with a selected content channel, selected Tagtopics^{SM} identifier, and a filled out body with another Tagtopics^{SM} identifier in the body. This post is ready to be published.

In FIG. 4, the search bar is shown, in which a user can a toggle between Tagtopics^{SM} identifiers and “Users”.

FIG. 5 shows an active search.

FIG. 6 illustrates a channel selector in accordance with one aspect of the present invention, which is based on channels the user has subscribed to and is ordered based on user preference.

FIG. 7 illustrates individual channels content page. This is an amalgamation of all posts in Tagtopics^{SM} identifiers associated with this channel.

FIG. 8 shows the Tagtopics^{SM} identifier post gallery.

FIG. 9 illustrates a larger gallery layout in accordance with one aspect of the present invention, in which users can select posts to see.

FIG. 10 illustrates a category (or “channel”) list.

FIG. 11 illustrates an exemplary category (or “channel”) browser in accordance with one aspect of the invention.

FIG. 12 is an entity relationship diagram relating to content creation and databasing of posts, including categories (e.g. “Lifestyle Channels”), Tagtopics^{SM} objects and tags, in accordance with one aspect of the present invention.

FIG. 13 illustrates a tabulation of interrelationship between tags generally (or Tagtopics^{SM} identifiers in certain embodiments) and predetermined categories generally (or “Channels”, “Lifestyle Channels” or “Lifestyles” in certain embodiments) in accordance with one aspect of the present invention.

FIG. 14 is an entity relationship diagram, relating to subscription and browsing functions of systems in accordance with the present invention, between users, predetermined or predefined categories (e.g. “Lifestyle Channel”), and Tagtopics^{SM} identifiers, in accordance with one aspect of the present invention.

FIG. 15 shows a block diagram illustrating aspects of an exemplary embodiment of a user interface controller in accordance with one exemplary embodiment of the invention.

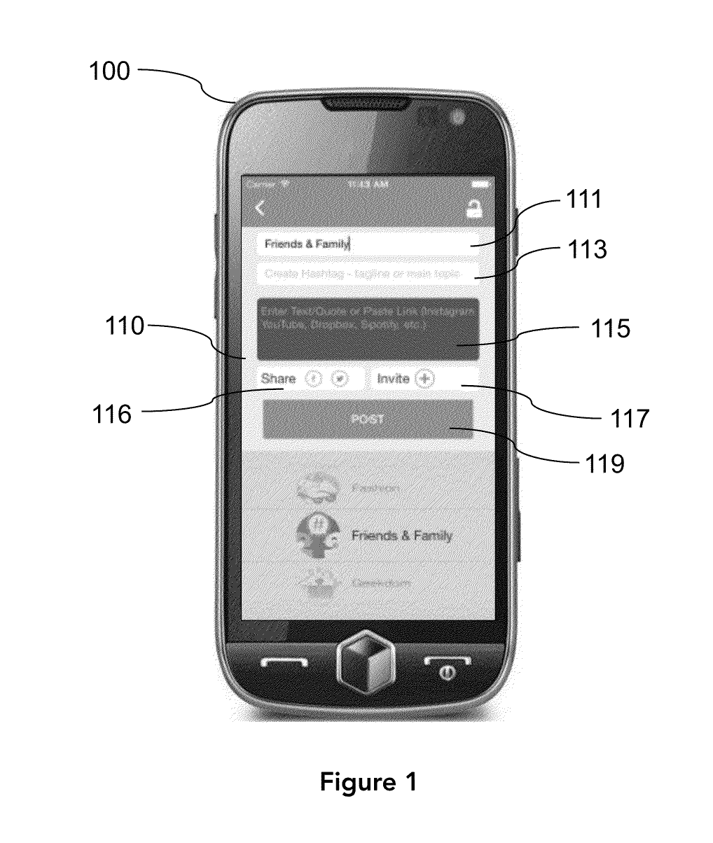

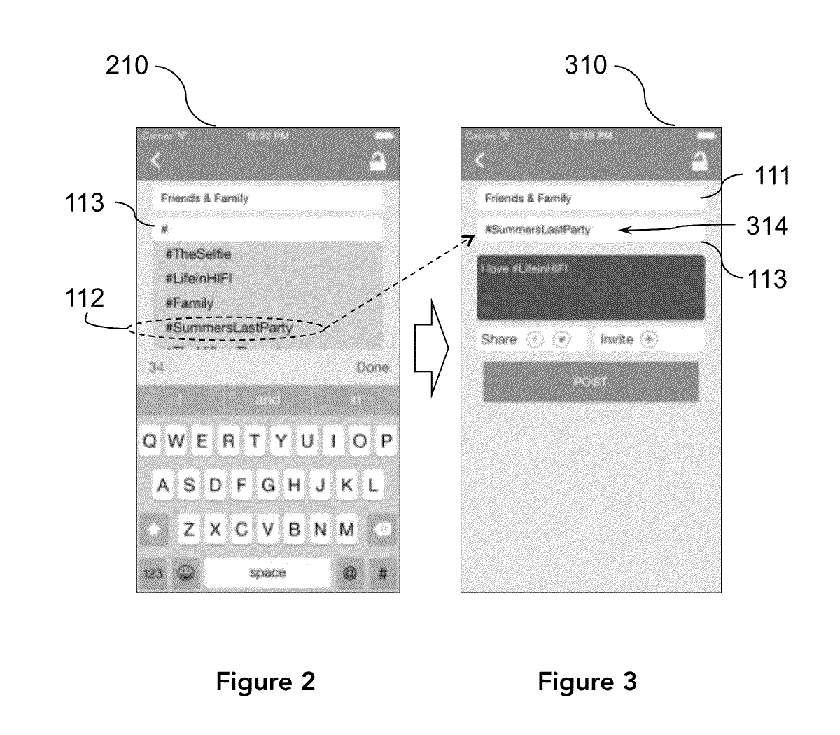

The leading number of each reference number within the drawings indicates the figure in which that reference number is introduced and/or detailed. As such, a detailed discussion of reference number 101 would be found and/or introduced in FIG. 1, with reference number 201 being introduced in FIG. 2, as follows:
100 Mobile device.
101 Screen of mobile device 100.
110 Graphical user interface (GUI) page, displayed on screen 101 illustrating a creation of content step.
111 User-selectable category (e.g., metadata) field (e.g., “Lifestyles” or “Channels” or Tagtopics^{SM} identifiers).
112 Indication of user selection.
113 User-definable category (e.g., metadata) field (e.g., freeform “hashtag”).
115 User-definable content field (e.g., a “Post”).
116 Share button to link with outside systems.
117 Invite button to message known contacts directly.
119 Post button to complete submission of content and associated indexing data.
210 Graphical user interface (GUI) page illustrating a step in creation of content.
310 Graphical user interface (GUI) page illustrating a step in creation of content.
314 Selected user-defined category.
410 Graphical user interface (GUI) page illustrating a step in browsing of existing content.
411 Available user-selectable categories.
510 Graphical user interface (GUI) page illustrating a step in browsing of existing content.
511 Various user-selectable categories associated with syntactically identical or otherwise closely related user-definable categories.
513 Suggested user-definable categories associated with different user-selectable categories when browsing.
610 Graphical user interface (GUI) page illustrating browsing by user-selectable categories.
611 User-selectable category options when browsing.
612 Indication of user selection of user-selectable category.
710 Graphical user interface (GUI) page illustrating a step in browsing of content and prioritizing user selectable categories (e.g., “Lifestyles” or “Channels” or Tagtopics^{SM} identifiers).
711 Selected user-selectable category.
713a,b Suggested extant user-definable categories already associated with content related to selected user-selectable category.
810 Graphical user interface (GUI) page illustrating a step in browsing of content and prioritizing user-definable categories (e.g., “hashtag”)
813 Selected extant user-definable category
818 Suggested extant content (“posts”) already associated with selected user-definable category.
910 Graphical user interface (GUI) page illustrating a step in browsing of content and prioritizing user-definable categories
918 Selected extant content (e.g., a “post”) already associated with selected user-definable category.
1010 Graphical user interface (GUI) page illustrating a step in browsing of content and prioritizing user-selectable categories (e.g., “Lifestyles” or “Channels” or Tagtopics^{SM} identifiers).
1110 Graphical user interface (GUI) page illustrating a step in browsing of content and prioritizing user-selectable categories (e.g., “Lifestyles” or “Channels” or Tagtopics^{SM} identifiers).
1501 Example system controller.
1502 Computer systemization.
1503 CPU.
1504 System bus.
1505 RAM.
1506 ROM.
1508 Input/output interface.
1509 Storage interface.
1510 Network interface.
1511 User input device.
1512 Peripheral device(s).
1513 Communications network.
1514 Storage device.
1515 Operating system.
1516 Information server.
1517 User interface.
1518 Web browser.
1519 Database.
1520 Cryptography server.
1521 Mail server.
1522 Mail client.
1528 Cryptography device.
1529 Memory.
1530 Clock.
1533a User(s).
1533b Client(s).
1535 System component for hierarchical categorization of collaborate tagging.
1574 Transceiver.
1575 Antenna.

### DETAILED DESCRIPTION

In accordance with one preferred aspect of the present invention, users experience a hierarchy of categorized index identifiers (generally, “tags”) explicitly during all phases of engagement with systems in accordance with the present invention. These tags are a major driving force behind the user experience. Three areas of particular relevance in the context of the present invention are content creation, searching, and browsing, as will be described further herein below.

### Content Creation

When a user creates content in the form of a post, they must choose both which category it appears in, and which tags to associate with it. They start by selecting a category. We call this the “content channel” or alternatively, “lifestyle” category. In accordance with the invention, many categories are provided that users can select to give context to their post.

FIG. 1 shows the first step in content creation. The content channel (or alternatively “lifestyle”) chosen provides posts with the first level of contextualization. This allows posts to be categorized for searching and browsing.

Selecting a content channel is the first tier of contextualization. The user then goes on to fill in the main Tagtopics^{SM} identifier with a hashtag. Further tags can be added to the body of the post to give even more detail to the post.

FIG. 2 shows the suggest list of Tagtopics^{SM} identifiers these are already created Tagtopics^{SM} identifiers that the user follows and uses frequently.

FIG. 3 shows a post with a selected content channel, selected Tagtopics^{SM} identifier, and a filled out body with another Tagtopics^{SM} identifier in the body. This post is ready to be published.

The key here is that each Tagtopics^{SM} identifier is unique, but only within the content channel category. For example, a user could have other “#SummersLastParty” Tagtopics^{SM} identifiers in other content channels with collaborative content applicable to that specific content channel.

### Content Creation Searching

When a user searches for content, searches may be done within the scope of Tagtopics^{SM} identifiers or users. Searching by Tagtopics^{SM} identifier returns all Tagtopics^{SM} identifiers containing a user's search text.

In FIG. 4, the search bar is shown. Here a user can toggle for Tagtopics^{SM} identifiers and “Users”. A user can toggle between these while he or she have an active search to change the scope on the fly.

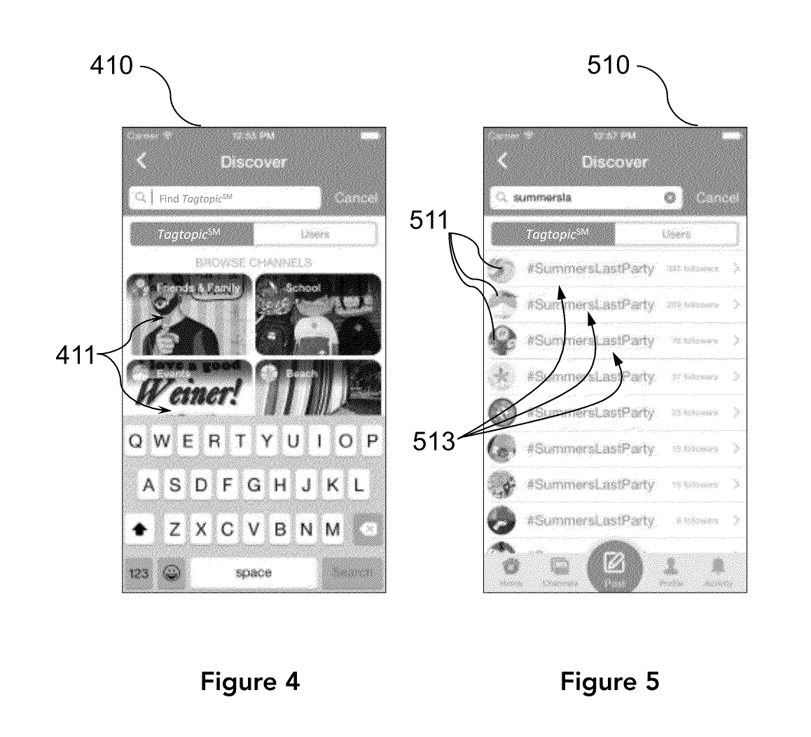

FIG. 5 shows an active search. The returned result shows a good example of contextualized Tagtopics^{SM} identifiers. There are a lot of different Tagtopics^{SM} identifiers for “SummersLastParty”, but they each are in a different channel. The icon to the left of the hashtag indicates what “content channel” channel each of those are in. Each one will have different collaborative content for the Tagtopics^{SM} identifiers.

### Content Subscription and Browsing

Users have a lot of options for how they consume content in accordance with the systems and methods of the present invention. This is in part because of the way the content is contextualized. There are two main facets of this. Content a user has subscribed to, and discovering new content a user wants to subscribe to. For content a user has subscribed to, one way is viewing posts by content channel.

This is a great way to browse content from the broad overview of the parent channels.

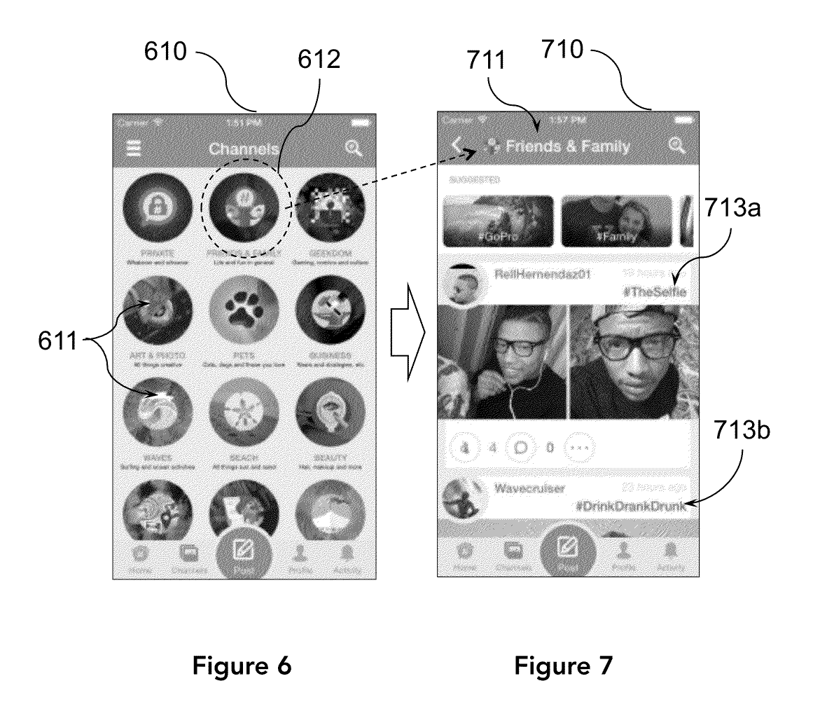

FIG. 6 shows the channel selector. This list is based on channels the user has subscribed to and is ordered based on user preference. When a user selects a channel, they are taken that channels content page show in FIG. 7.

In FIG. 7 we see an individual channels content page. This is an amalgamation of all posts in Tagtopics^{SM} identifiers associated with this channel. At the top, we see a list of the suggested/most popular Tagtopics^{SM} identifier. Below that we see a list of posts.

Users can also view content based on an individual Tagtopics^{SM} identifier. They can do this by selecting a Tagtopics^{SM} identifier on a post, or by search for it. This shows a gallery layout of all posts in that particular Tagtopics^{SM} identifier. This also provides related information about that Tagtopics^{SM} identifier such as the number of followers, the creator, the most popular post, and allows users to invite other users to follow this Tagtopics^{SM} identifier.

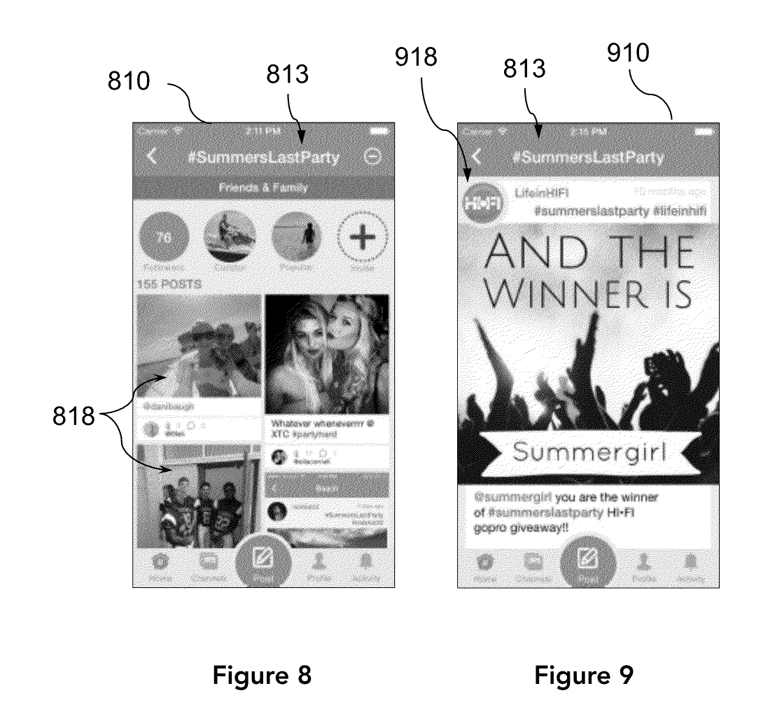

FIG. 8 shows the Tagtopics^{SM} identifier post gallery. This shows all posts in that individual Tagtopics^{SM} identifier ordered by most recent first. A user can also still see which channel the Tagtopics^{SM} identifier is associated with. A user has the option to subscribe and unsubscribe from this Tagtopics^{SM} identifier via the “Follow/Unfollow” button in the top right corner, for example.

Advantageously, this aspect of the invention provides for deep context collaborative user content. This is because the hashtags used when making content aren't just something thrown on at the end, but a key part of the entire user experience.

Users can also select posts to see a larger gallery layout as seen in FIG. 9. This is the full layout and allows users to view, comment, and “like” content, for example.

In accordance with a preferred aspect of the invention, discoverability is also a valuable part of the user experience of systems in accordance with the invention. It is preferred that users be able to easily find new content to which they can subscribe, and to which they can begin adding collaborative content. Users can discover new content by browsing content they haven't subscribed to from each channel.

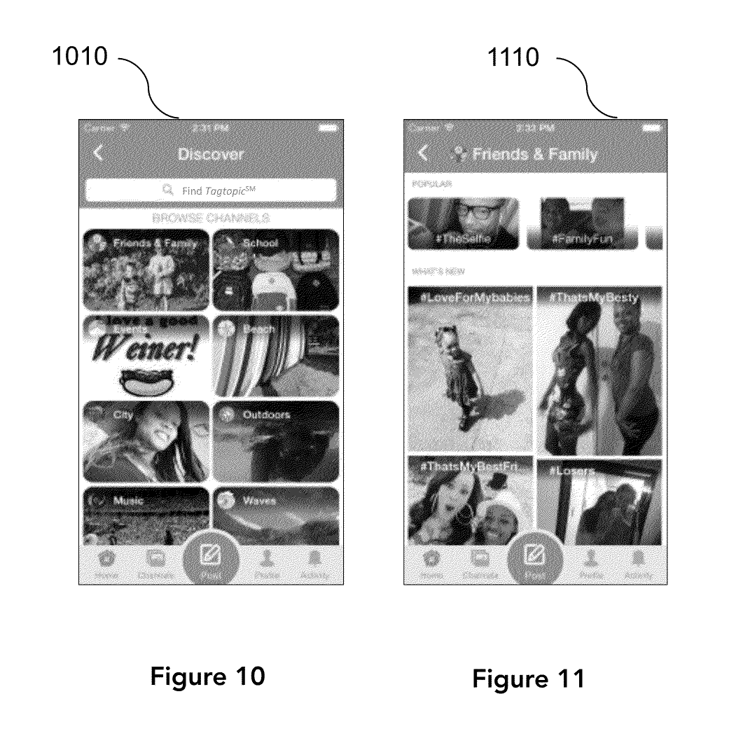

FIG. 10 shows the a category (content channel) list. In accordance with the illustrated embodiment, this list doesn't just show channels to which a user is subscribed, but rather all channels. Advantageously, this allows users to browse content that is likely new to them. Selecting a channel will take a user to the channel browser, as illustrated, for example, in FIG. 11.

The channel browser gives a much more broad overview than the normal channel list, some such differences can be seen in FIG. 11. In accordance with the illustrated embodiment, the posts seen here are only from Tagtopics^{SM} to which the user has not yet subscribed. Advantageously, users are encouraged to explore new content that may prove to be of interest to them.

In accordance with a preferred embodiment, a user can see Tagtopics^{SM} ordered by most popular, or alternatively, with newer Tagtopics^{SM} being shown first. In accordance with a presently preferred embodiment, selecting one of the presented Tagtopics^{SM} will lead a user into a gallery view where the user can subscribe or unsubscribe from the selected channel.

### Example Implementation

### Content Creation

It is preferred, in accordance with the present invention, that content creation be relatively straightforward. When a user submits a post, the database creates a new post object and assigns it the next available post ID. A many-to-one relationship is established between the post object and the content channel. A one-to-many relationship is established between the post object and any tags on the post.

Tags have a many-to-one relationship with Tagtopics^{SM} identifier and Tagtopics^{SM} identifiers have a many-to-one relationship with categories (e.g., “Lifestyle Channels”). In this way a hierarchy is created where each post has a content channel and each channel has Tagtopics^{SM} identifiers associated with it. Each Tagtopics^{SM} identifier is unique by name within its Category (or “Lifestyle Channel”).

In accordance with one preferred embodiment, if a user submits a post with a new (non-extant) Tagtopics^{SM} identifier that doesn't exist in that category (or content channel) then a new Tagtopics^{SM} identifier is created and the appropriate relationships are established as illustrated and described elsewhere in this document.

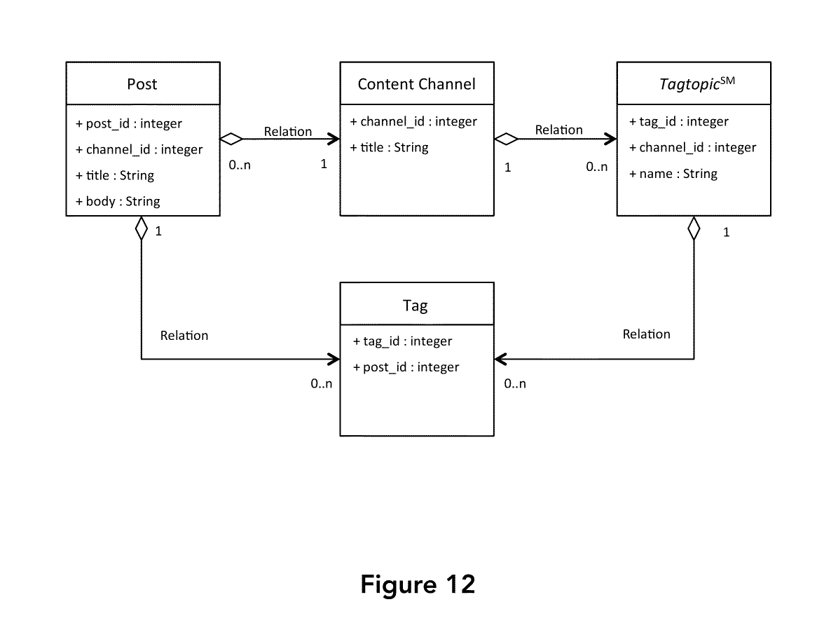

With reference to FIG. 12, and in accordance with one preferred aspect of the invention, a post record (e.g., “content”) can contain Tagtopics^{SM} identifiers in either the title (typically a metadata field), the body (typically otherwise a content field), or both. The entity relationship diagram is provided below in FIG. 12.

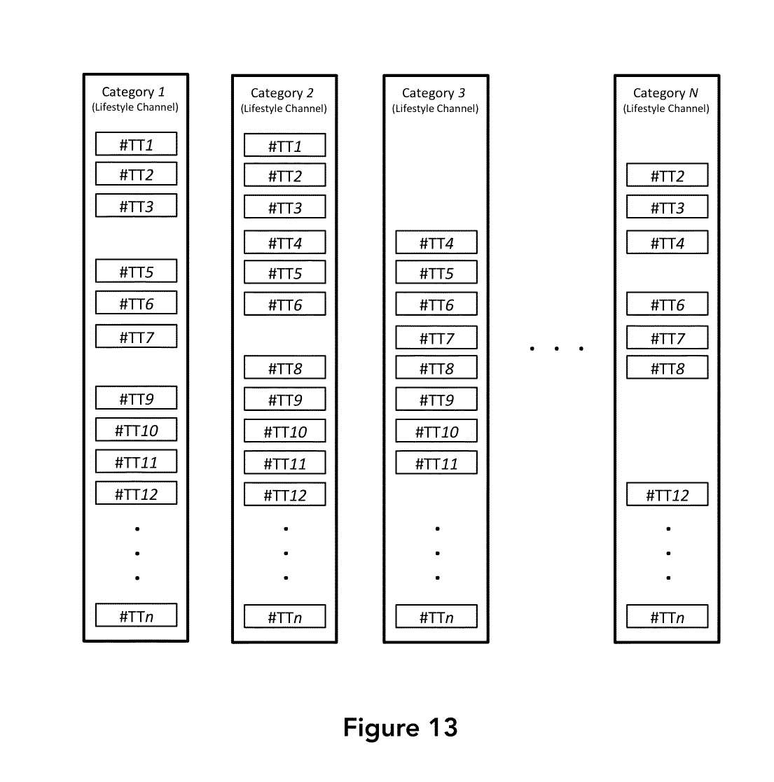

In accordance with a preferred implementation of the invention, a lexicographically identical tag (e.g. #tag1, or “#TT1”, as illustrated) is created in the system, and related to one or many categories (e.g. “Category 1”), as shown in FIG. 13, for example. In accordance with a preferred embodiment, the user the categories are called “Lifestyles” or alternatively, “Lifestyle Channels” and the tags are called Tagtopics^{SM}.

### Content Searching

In accordance with one aspect of the invention, content keyword searching can be done in one of two ways. For example, a user can search for Tagtopics^{SM}, or for other users. Either of these foregoing examples are substantially functionally similar, although this would depend on the precise implementation, as will be appreciated. For example, a user inputs text into a search field. A live search is performed as the user types into the search field. In accordance with this example, the system performs a “contains” query on a related database for either user or Tagtopics^{SM}. In the case of a Tagtopics^{SM} identifier-based search, the query is performed on the names of all the Tagtopics^{SM} identifiers. The query then returns all results to the user as a list of Tagtopics^{SM}.

### Content Subscription and Browsing

In accordance with a preferred implementation of the invention, users follow both predetermined categories (e.g., “content channels”) each of which covers, respectively, a relevant content channel area related to commonly disseminated Web-based information and Tagtopics^{SM} within those categories. When a user chooses to follow a category, a many-to-many relationship is established in the respective database between the user and the category. In accordance with a presently preferred implementation, the same is true for Tagtopics^{SM}. When a user follows a Tagtopics^{SM} identifier, a many-to-many relationship is established in the database. When a user initially follows a channel they aren't initially following any Tagtopics^{SM} within that channel.

In accordance with a presently preferred aspect, users encounter or “discover” new collaborative Tagtopics^{SM} to follow by browsing the “discover” channel. The page associated with the “discover” channel, in this exemplary embodiment, returns Tagtopics^{SM} identifiers the user isn't yet following (e.g., for a specific category or “content channel”). Again, when a user follows a Tagtopics^{SM} identifier, a many-to-many relationship is established. Content from that Tagtopics^{SM} identifier will then begin appearing in the feed of the user.

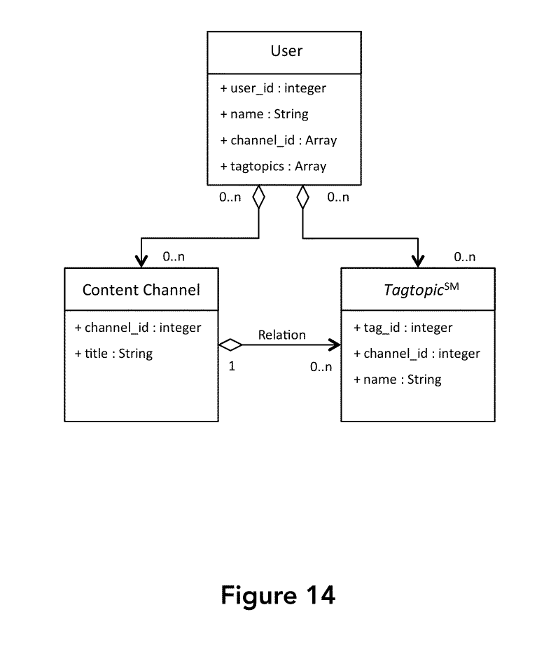

In accordance with this preferred embodiment, from within the “discover channel” it is possible for users to follow Tagtopics^{SM} in categories (content channels or alternatively “lifestyle channels”) that they aren't following. When the user does this, and a many-to-many relationship is created between the Tagtopics^{SM} identifier and the user, a relationship between the user and that Tagtopics^{SM} identifier's parent channel is also created, as illustrated in the entity relationship diagram of FIG. 14, for example.

### Hi-Fi Mobile Lifestyle Network™

The subject systems and methods for hierarchical categorization of collaborative tagging (hereinafter “Hi-Fi MLN”) will be described in further detail.

### Hi-Fi MLN Controller

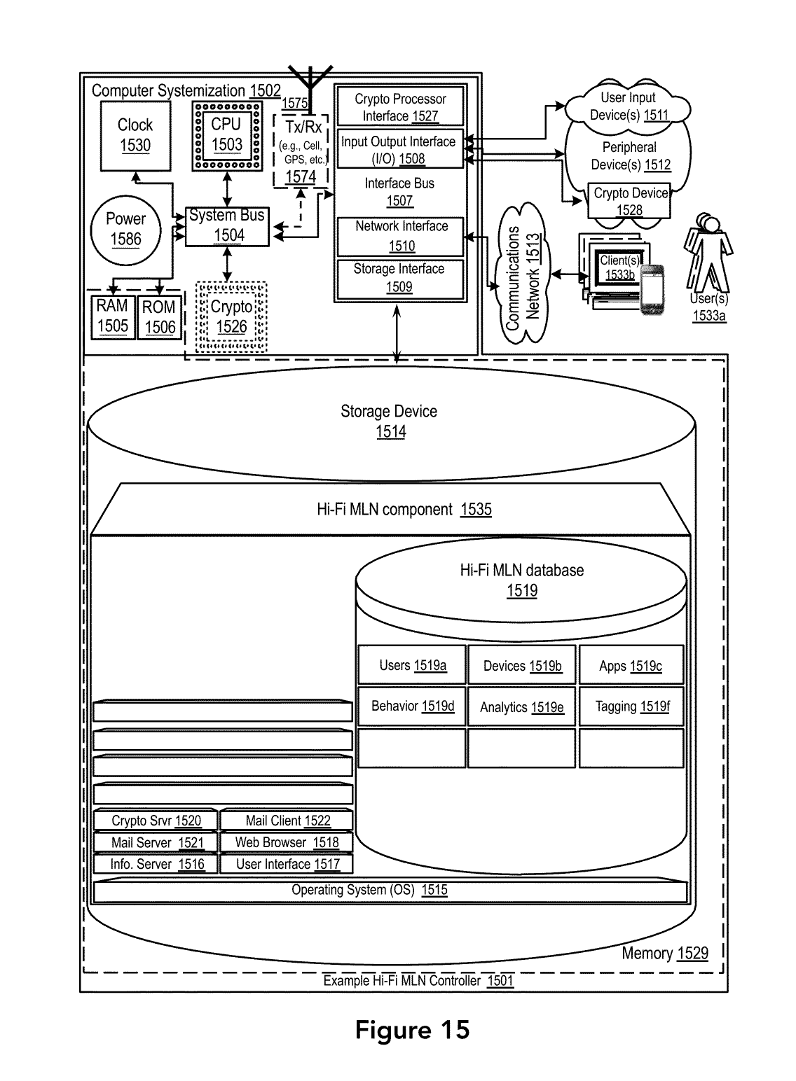

Turning now to FIG. 15, a block diagram is shown illustrating example aspects of a Hi-Fi MLN controller 1501. In this embodiment, the Hi-Fi MLN controller 1501 may serve to aggregate, process, store, search, serve, identify, instruct, generate, match, and/or facilitate interactions with a computer through various technologies, and/or other related data.

Users, e.g., 1533a, which may be people and/or other systems, may engage information technology systems (e.g., computers) to facilitate information processing. In turn, computers employ processors to process information; such processors 1503 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 1529 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the Hi-Fi MLN controller 1501 may be connected to and/or communicate with entities such as, but not limited to: one or more users from user input devices 1511; peripheral devices 1512; an optional cryptographic processor device 1528; and/or a communications network 1513. For example, the Hi-Fi MLN controller 1501 may be connected to and/or communicate with users, e.g., 1533a, operating client device(s), e.g., 1533b, including, but not limited to, personal computer(s), server(s) and/or various mobile device(s) including, but not limited to, cellular telephone(s), smartphone(s) (e.g., iPhone®, Blackberry®, Android OS-based phones etc.), tablet computer(s) (e.g., Apple iPad™, HP Slate™, Motorola Xoom™, etc.), eBook reader(s) (e.g., Amazon Kindle™, Barnes and Noble's Nook™ eReader, etc.), laptop computer(s), notebook(s), netbook(s), gaming console(s) (e.g., XBOX Live™, Nintendo® DS, Sony PlayStation® Portable, etc.), portable scanner(s), and/or the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The Hi-Fi MLN controller 1501 may be based on computer systems that may comprise, but are not limited to, components such as: a computer systemization 1502 connected to memory 1529.

### Computer Systemization

A computer systemization 1502 may comprise a clock 1530, central processing unit (“CPU(s)” and/or “processor(s)” (these terms are used interchangeably throughout the disclosure unless noted to the contrary)) 1503, a memory 1529 (e.g., a read only memory (ROM) 1506, a random access memory (RAM) 1505, etc.), and/or an interface bus 1507, and most frequently, although not necessarily, are all interconnected and/or communicating through a system bus 1504 on one or more (mother)board(s) 1502 having conductive and/or otherwise transportive circuit pathways through which instructions (e.g., binary encoded signals) may travel to effectuate communications, operations, storage, etc. The computer systemization may be connected to a power source 1586; e.g., optionally the power source may be internal. Optionally, a cryptographic processor 1526 and/or transceivers (e.g., ICs) 1574 may be connected to the system bus. In another embodiment, the cryptographic processor and/or transceivers may be connected as either internal and/or external peripheral devices 1512 via the interface bus I/O. In turn, the transceivers may be connected to antenna(s) 1575, thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing Hi-Fi MLN controller to determine its location, if desired)); Broadcom BCM4329FKUBG transceiver chip (e.g., providing 802.11n, Bluetooth 2.1+EDR, FM, etc.), BCM28150 (HSPA+) and BCM2076 (Bluetooth 4.0, GPS, etc.); a Broadcom BCM4750IUB8 receiver chip (e.g., GPS); an Infineon Technologies X-Gold 618-PMB9800 (e.g., providing 2G/3G HSDPA/HSUPA communications); Intel's XMM 7160 (LTE & DC-HSPA), Qualcom's CDMA(2000), Mobile Data/Station Modem, Snapdragon; and/or the like. The system clock may have a crystal oscillator and generates a base signal through the computer systemization's circuit pathways. The clock may be coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: floating point units, integer processing units, integrated system (bus) controllers, logic operating units, memory management control units, etc., and even specialized processing sub-units like graphics processing units, digital signal processing units, and/or the like. Additionally, processors may include internal fast access addressable memory, and be capable of mapping and addressing memory 1529 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state/value. The CPU may be a microprocessor such as: AMD's Athlon, Duron and/or Opteron; ARM's classic (e.g., ARM7/9/11), embedded (Coretx-M/R), application (Cortex-A), embedded and secure processors; IBM and/or Motorola's DragonBall and PowerPC; IBM's and Sony's Cell processor; Intel's Atom, Celeron (Mobile), Core (2/Duo/i3/i5/i7), Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code). Such instruction passing facilitates communication within the Hi-Fi MLN controller and beyond through various interfaces. Should processing requirements dictate a greater amount speed and/or capacity, distributed processors (e.g., Distributed Hi-Fi MLN), mainframe, multi-core, parallel, and/or super-computer architectures may similarly be employed. Alternatively, should deployment requirements dictate greater portability, smaller mobile devices (e.g., smartphones, Personal Digital Assistants (PDAs), etc.) may be employed.

Depending on the particular implementation, features of the Hi-Fi MLN may be achieved by implementing a microcontroller such as CAST's R8051XC2 microcontroller; Intel's MCS 51 (i.e., 8051 microcontroller); and/or the like. Also, to implement certain features of the Hi-Fi MLN, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the Hi-Fi MLN component collection (distributed or otherwise) and/or features may be implemented via the microprocessor and/or via embedded components; e.g., via ASIC, coprocessor, DSP, FPGA, and/or the like. Alternately, some implementations of the Hi-Fi MLN may be implemented with embedded components that are configured and used to achieve a variety of features or signal processing.

Depending on the particular implementation, the embedded components may include software solutions, hardware solutions, and/or some combination of both hardware/software solutions. For example, Hi-Fi MLN features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the Hi-Fi MLN features. A hierarchy of programmable interconnects allow logic blocks to be interconnected as needed by the Hi-Fi MLN system designer/administrator, somewhat like a one-chip programmable breadboard. An FPGA's logic blocks can be programmed to perform the operation of basic logic gates such as AND, and XOR, or more complex combinational operators such as decoders or simple mathematical operations. In most FPGAs, the logic blocks also include memory elements, which may be circuit flip-flops or more complete blocks of memory. In some circumstances, the Hi-Fi MLN may be developed on regular FPGAs and then migrated into a fixed version that more resembles ASIC implementations. Alternate or coordinating implementations may migrate Hi-Fi MLN controller features to a final ASIC instead of or in addition to FPGAs. Depending on the implementation all of the aforementioned embedded components and microprocessors may be considered the “CPU” and/or “processor” for the Hi-Fi MLN.

### Power Source

The power source 1586 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 1586 is connected to at least one of the interconnected subsequent components of the Hi-Fi MLN thereby providing an electric current to all the interconnected components. In one example, the power source 1586 is connected to the system bus component 1504. In an alternative embodiment, an outside power source 1586 is provided through a connection across the I/O 1508 interface. For example, a USB and/or IEEE 1394 connection carries both data and power across the connection and is therefore a suitable source of power.

### Interface Adapters

Interface bus(ses) 1507 may accept, connect, and/or communicate to a number of interface adapters, frequently, although not necessarily in the form of adapter cards, such as but not limited to: input output interfaces (I/O) 1508, storage interfaces 1509, network interfaces 1510, and/or the like. Optionally, cryptographic processor interfaces 1527 similarly may be connected to the interface bus. The interface bus provides for the communications of interface adapters with one another as well as with other components of the computer systemization. Interface adapters are adapted for a compatible interface bus. Interface adapters may connect to the interface bus via expansion and/or slot architecture. Various expansion and/or slot architectures may be employed, such as, but not limited to: Accelerated Graphics Port (AGP), Card Bus, ExpressCard, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), Thunderbolt, and/or the like.

Storage interfaces 1509 may accept, communicate, and/or connect to a number of storage devices such as, but not limited to: storage devices 1514, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, Ethernet, fiber channel, Small Computer Systems Interface (SCSI), Thunderbolt, Universal Serial Bus (USB), and/or the like.

Network interfaces 1510 may accept, communicate, and/or connect to a communications network 1513. Through a communications network 1513, the Hi-Fi MLN controller is accessible through remote clients 1533b (e.g., computers with web browsers) by users 1533a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed Hi-Fi MLN), architectures may similarly be employed to pool, load balance, and/or otherwise increase the communicative bandwidth required by the Hi-Fi MLN controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 1510 may be used to engage with various communications network types 1513. For example, multiple network interfaces may be employed to allow for the communication over broadcast, multicast, and/or unicast networks.

Input Output interfaces (I/O) 1508 may accept, communicate, and/or connect to user input devices 1511, peripheral devices 1512, cryptographic processor devices 1528, and/or the like. I/O may employ connection protocols such as, but not limited to: audio: analog, digital, monaural, RCA, stereo, and/or the like; data: Apple Desktop Bus (ADB), Bluetooth, IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, DisplayPort, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One output device may be a video display, which may take the form of a Cathode Ray Tube (CRT), Liquid Crystal Display (LCD), Light Emitting Diode (LED), Organic Light Emitting Diode (OLED), Plasma, and/or the like based monitor with an interface (e.g., VGA, DVI circuitry and cable) that accepts signals from a video interface. The video interface composites information generated by a computer systemization and generates video signals based on the composited information in a video memory frame. Another output device is a television set, which accepts signals from a video interface. Often, the video interface provides the composited video information through a video connection interface that accepts a video display interface (e.g., an RCA composite video connector accepting an RCA composite video cable; a DVI connector accepting a DVI display cable, HDMI, etc.).

User input devices 1511 often are a type of peripheral device 1512 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 1512 may be connected and/or communicate to I/O and/or other facilities of the like such as network interfaces, storage interfaces, directly to the interface bus, system bus, the CPU, and/or the like. Peripheral devices may be external, internal and/or part of the Hi-Fi MLN controller 1501. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 1528), force-feedback devices (e.g., vibrating motors), near field communication (NFC) devices, network interfaces, printers, radio frequency identifiers (RFIDs), scanners, storage devices, transceivers (e.g., cellular, GPS, etc.), video devices (e.g., goggles, monitors, etc.), video sources, visors, and/or the like. Peripheral devices often include types of input devices (e.g., microphones, cameras, etc.).

It should be noted that although user input devices and peripheral devices may be employed, the Hi-Fi MLN controller may be embodied as an embedded, dedicated, and/or monitor-less (i.e., headless) device, wherein access would be provided over a network interface connection.

Cryptographic units such as, but not limited to, microcontrollers, processors 1526, interfaces 1527, and/or devices 1528 may be attached, and/or communicate with the Hi-Fi MLN controller. A MC68HC16 microcontroller, manufactured by Motorola Inc., may be used for and/or within cryptographic units, for example. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: the Broadcom's CryptoNetX and other Security Processors; nCipher's nShield (e.g., Solo, Connect, etc.), SafeNet's Luna PCI (e.g., 7100) series; Semaphore Communications' 40 MHz Roadrunner 184; sMIP's (e.g., 208956); Sun's Cryptographic Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

### Memory

Generally, any mechanization and/or embodiment allowing a processor to affect the storage and/or retrieval of information is regarded as memory 1529. However, memory is a fungible technology and resource, thus, any number of memory embodiments may be employed in lieu of or in concert with one another. It is to be understood that the Hi-Fi MLN controller and/or a computer systemization may employ various forms of memory 1529. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In one configuration, memory 1529 may include ROM 1506, RAM 1505, and a storage device 1514. A storage device 1514 may employ any number of computer storage devices/systems. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 1529 may contain a collection of program and/or database components and/or data such as, but not limited to: operating system component(s) 1515 (operating system); information server component(s) 1516 (information server); user interface component(s) 1517 (user interface); Web browser component(s) 1518 (Web browser); database(s) 1519; mail server component(s) 1521; mail client component(s) 1522; cryptographic server component(s) 1520 (cryptographic server); the Hi-Fi MLN component(s) 1535; and/or the like (i.e., collectively a component collection). These components may be stored and accessed from the storage devices and/or from storage devices accessible through an interface bus. Although non-conventional program components such as those in the component collection may be stored in a local storage device 1514, they may also be loaded and/or stored in memory such as: peripheral devices, RAM, remote storage facilities through a communications network, ROM, various forms of memory, and/or the like.

### Operating System

The operating system component 1515 is an executable program component facilitating the operation of the Hi-Fi MLN controller 1501. The operating system may facilitate access of I/O, network interfaces, peripheral devices, storage devices, and/or the like. The operating system may be a highly fault tolerant, scalable, and secure system such as: Apple Macintosh OS X (Server); AT&T Nan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NTNista/XP (Server), Palm OS, and/or the like. In addition, emobile operating systems such as Apple's iOS, Google's Android, Hewlett Packard's WebOS, Microsofts Windows Mobile, and/or the like may be employed. Any of these operating systems may be embedded within the hardware of the NICK controller, and/or stored/loaded into memory/storage. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the Hi-Fi MLN controller to communicate with other entities through a communications network 1513. Various communication protocols may be used by the Hi-Fi MLN controller 1501 as a subcarrier transport mechanism for interaction, such as, but not limited to: multicast, TCP/IP, UDP, unicast, and/or the like.

### Information Server

An information server component 1516 is a stored program component that is executed by a CPU. The information server may be an Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Apple's iMessage, Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the Hi-Fi MLN controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the Hi-Fi MLN database 1519, operating systems, other program components, user interfaces, Web browsers, and/or the like.

Access to the Hi-Fi MLN database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the Hi-Fi MLN. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the Hi-Fi MLN as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua and iOS's Cocoa Touch, IBM's OS/2, Google's Android Mobile UI, Microsoft's Windows 2000/2003/3.1/95/98/CE/Millenium/Mobile/NT/XPNista/7/8 (i.e., Aero, Metro), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 1517 is a stored program component that is executed by a CPU. The user interface may be a graphic user interface as provided by, with, and/or atop operating systems and/or operating environments such as already discussed herein above and illustrated in the accompanying drawings. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 1518 is a stored program component that is executed by a CPU. The Web browser may be a hypertext viewing application such as Google's (Mobile) Chrome, Microsoft Internet Explorer, Netscape Navigator, Apple's (Mobile) Safari, embedded web browser identifiers such as through Apple's Cocoa (Touch) object class, and/or the like. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., Chrome, FireFox, Internet Explorer, Safari Plug-in, and/or the like APIs), and/or the like. Web browsers and like information access tools may be integrated into PDAs, cellular telephones, smartphones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly effect the obtaining and the provision of information to users, user agents, and/or the like from the Hi-Fi MLN equipped nodes. The combined application may be nugatory on systems employing standard Web browsers.

### Mail Server

A mail server component 1521 is a stored program component that is executed by a CPU 1503. The mail server may be an Internet mail server such as, but not limited to Apple's Mail Server (3), dovect, sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POPS), simple mail transfer protocol (SMTP), and/or the like. The mail server can route, forward, and process incoming and outgoing mail messages that have been sent, relayed and/or otherwise traversing through and/or to the Hi-Fi MLN. Access to the Hi-Fi MLN mail may be achieved through a number of APIs offered by the individual Web server components and/or the operating system. Also, a mail server may contain, communicate, generate, obtain, and/or provide program component, system, user, and/or data communications, requests, information, and/or responses.

### Mail Client

A mail client component 1522 is a stored program component that is executed by a CPU 1503. The mail client may be a mail viewing application such as Apple (Mobile) Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 1520 is a stored program component that is executed by a CPU 1503, cryptographic processor 1526, cryptographic processor interface 1527, cryptographic processor device 1528, and/or the like. Cryptographic processor interfaces will allow for expedition of encryption and/or decryption requests by the cryptographic component; however, the cryptographic component, alternatively, may run on a CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1577 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the Hi-Fi MLN may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the Hi-Fi MLN component to engage in secure transactions if so desired. The cryptographic component facilitates the secure accessing of resources on the Hi-Fi MLN and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The Hi-Fi MLN Database

The Hi-Fi MLN database component 1519 may be embodied in a database and its stored data. The database is a stored program component, which is executed by the CPU; the stored program component portion configuring the CPU to process the stored data. The database may be any of a number of fault tolerant, relational, scalable, secure databases, such as DB2, MySQL, Oracle, Sybase, and/or the like. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the Hi-Fi MLN database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the Hi-Fi MLN database is implemented as a data-structure, the use of the Hi-Fi MLN database 1519 may be integrated into another component such as the Hi-Fi MLN component 1535. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In accordance with the invention, as illustrated, the database component 1519 may include several tables 1519a-f. For example, a Users table 1519a may include fields such as, but not limited to: user_id, ssn, dob, first_name, last_name, age, state, address_firstline, address_secondline, zipcode, devices_list, contact_info, contact_type, alt_contact_info, alt_contact_type, and/or the like. The Users table 1519a may support and/or track multiple entity accounts on a Hi-Fi MLN. A Devices table 1519b may include fields such as, but not limited to: device ID, device_name, device_IP, device_GPS, device_MAC, device_serial, device_ECID, device_UDID, device_browser, device_type, device_model, device_version, device_OS, device_apps_list, device_securekey, wallet_app_installed_flag, and/or the like. An Apps table 1519c may include fields such as, but not limited to: app_ID, app_name, app_type, app dependencies, app access code, user_pin, and/or the like. A Behavior Data table 1519d may include fields such as, but not limited to: user_id, timestamp, activity_type, activity_location, activity_attribute_list, activity_attribute_values_list, and/or the like.

An Analytics table 1519e may include fields such as, but not limited to: report_id, user_id, report_type, report_algorithm_id, report_destination_address, and/or the like. In accordance with one aspect of the invention, the Hi-Fi MLN database may interact with other database systems. For example, employing a distributed database system, queries and data access by search, the Hi-Fi MLN component 1535 may treat the combination of the Hi-Fi MLN database and information reposed on one or more other databases as a single database entity. One or more Tagging tables 1519f can be provided and may include fields such as, but not limited to: post_id, channel_id, title, body, name, tag_id, tagtopics, and/or the like.

In one embodiment, user programs may contain various user interface primitives, which may serve to update the Hi-Fi MLN. Also, various accounts may require custom database tables depending upon the environments and the types of clients the Hi-Fi MLN may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 1519a-f. The Hi-Fi MLN may be configured to keep track of various settings, inputs, and parameters via database controllers.

The Hi-Fi MLN database may communicate to and/or with other components in a component collection, including itself, and/or facilities of the like. Most frequently, the Hi-Fi MLN database communicates with the Hi-Fi MLN component, other program components, and/or the like. The database may contain, retain, and provide information regarding other nodes and data.

### The Hi-Fi MLN

The Hi-Fi MLN component 1535 is a stored program component that is executed by a CPU. In one embodiment, the Hi-Fi MLN component incorporates any and/or all combinations of the aspects of the Hi-Fi MLN discussed in the previous figures. As such, the Hi-Fi MLN affects accessing, obtaining and the provision of information, services, transactions, and/or the like across various communications networks. The features and embodiments of the Hi-Fi MLN discussed herein increase network efficiency by reducing data transfer requirements, the use of more efficient data structures and mechanisms for their transfer and storage. As a consequence, more data may be transferred in less time, and latencies with regard to transactions, are also reduced. In many cases, such reduction in storage, transfer time, bandwidth requirements, latencies, etc., will reduce the capacity and structural infrastructure requirements to support the Hi-Fi MLN's features and facilities, and in many cases reduce the costs, energy consumption/requirements, and extend the life of Hi-Fi MLN's underlying infrastructure; this has the added benefit of making the Hi-Fi MLN more reliable. Similarly, many of the features and mechanisms are designed to be easier for users to use and access, thereby broadening the audience that may enjoy/employ and exploit the feature sets of the Hi-Fi MLN; such ease of use also helps to increase the reliability of the Hi-Fi MLN. In addition, the feature sets include heightened security as noted via the Cryptographic components 1520, 1526, 1528 and throughout, making access to the features and data more reliable and secure.

The Hi-Fi MLN component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the Hi-Fi MLN server employs a cryptographic server to encrypt and decrypt communications. The Hi-Fi MLN component may communicate to and/or with other components in a component collection, including itself, and/or facilities of the like. Most frequently, the Hi-Fi MLN component communicates with the Hi-Fi MLN database, operating systems, other program components, and/or the like. The Hi-Fi MLN may contain, communicate, generate, obtain, and/or provide program component, system, user, and/or data communications, requests, and/or responses.

### Distributed Hi-Fi MLNs

The structure and/or operation of any of the Hi-Fi MLN node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the Hi-Fi MLN controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.: w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the Hi-Fi MLN controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

TABLE-US-00034<?PHP header(‘Content-Type: text/plain’); // set ip address and port to listen to for incoming data $address=‘192.168.0.100’; $port=255; // create a server-side SSL socket, listen for/accept incoming communication $sock=socket_create(AF_INET, SOCK_STREAM, 0); socket bind($sock, $address, $port) or die(‘Could not bind to address’); socket_listen($sock); $client=socket_accept($sock); //read input data from client device in 1024 byte blocks until end of message do {$input=“ ”; $input=socket_read($client, 1024); $data.=$input;} while($input !=“ ”); // parse data to extract variables $obj=json_decode($data, true); // store input data in a database mysql_connect(“201.408.185.132”,$DBserver,$password); // access database server mysql_select(“CLIENT_DB.SQL”); // select database to append mysql_query(“INSERT INTO UserTable (transmission) VALUES ($data)”); // add data to UserTable table in a CLIENT database mysql_close(“CLIENT_DB.SQL”); // close connection to database ?>

Also, the following resources may be used to provide example embodiments regarding SOAP parser implementation:

TABLE-US-00035 http://www.xay.com/perl/site/lib/SOAP/Parser.html http://publib.boulder.ibm.com/infocenter/tivihelp/v2r1/index.jsp?topic=/com.ibm.IBMDI.doc/referenceguide295.htm

and other parser implementations:

TABLE-US-00036 http://publib.boulder.ibm.com/infocenter/tivihelp/v2r1/index.jsp?topic=/com.ibm.IBMDI.doc/referenceguide259.htm

all of which are hereby expressly incorporated by reference herein.

In order to address various issues and advance the art, the entirety of this application for systems and methods for hierarchical categorization of collaborative tagging (including the Cover Page, Title, Headings, Field, Background, Summary, Brief Description of the Drawings, Detailed Description, Claims, Abstract, Figures, and any Appendices and/or otherwise) shows by way of illustration various embodiments in which the claimed inventions may be practiced. The advantages and features of the application are of a representative sample of embodiments only, and are not exhaustive and/or exclusive. They are presented only to assist in understanding and teach the claimed principles. It should be understood that they are not representative of all disclosed embodiments. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims. It is to be understood that, depending on the particular needs and/or characteristics of a Hi-Fi MLN individual and/or enterprise user, database configuration and/or relational model, data type, data transmission and/or network framework, syntax structure, and/or the like, various embodiments of the Hi-Fi MLN may be implemented that enable a great deal of flexibility and customization. For example, aspects of the Hi-Fi MLN may be advantageously adapted for document cataloguing internal to a business (enterprise) and/or the like, as will be appreciated by those skilled in the art. While various embodiments and discussions of the Hi-Fi MLN have been directed to social bookmarking, it is nevertheless to be understood that the embodiments described herein may be readily configured and/or customized for a wide variety of other applications and/or implementations.

1) A method of hierarchically categorizing collaborative indexing tags, comprising:
a) receiving first data relating to a first post object, the first data including:
i) a user-selected first category identifier, selected from a first group of predetermined identifiers;
ii) a user-defined second category identifier; and
iii) a first content object;
b) receiving a request to publish the first post object;
c) assigning a first unique identifier to the first post object;
d) correlating the user-selected first category identifier with a first category identifier database;
e) correlating the user-defined second category identifier with a second category identifier database; and
f) populating a first data structure with the user-selected first category identifier, the user-defined second category identifier, and the first unique identifier of the first post object for storage and later retrieval.

2) The method of claim 1, wherein the first content object includes a user-defined third category identifier, which is parsed from first content object, the method further comprising the steps of:
g) correlating the user-defined third category identifier with the second category identifier database; and
h) populating the first data structure additionally with the user-defined third category identifier of the first post object, for storage and later retrieval.

3) The method of claim 2, wherein the first content object further includes a user-defined fourth category identifier, which is parsed from first content object, the method further comprising the steps of:
i) correlating the user-defined fourth category identifier with the second category identifier database; and
j) populating the first data structure additionally with the user-defined fourth category identifier of the first post object, for storage and later retrieval.

4) The method of claim 1, further comprising the step of:
g) populating a second data structure, the second data structure correlating one or more user-selected first category identifiers with one or more user-defined second category identifiers, when said first and second category identifiers have been used in connection with the same post object.

5) The method of claim 1, wherein the first content object further includes at least one hyperlink.

6) An apparatus for hierarchically categorizing collaborative indexing tags, the apparatus comprising: a processor; and a memory coupled to the processor, wherein the memory comprises instructions which, when executed by the processor, cause the processor to:
a) receive first data relating to a first post object, the first data including:
i) a user-selected first category identifier, selected from a first group of predetermined identifiers;
ii) a user-defined second category identifier; and
iii) a first content object;
b) receive a request to publish the first post object;
c) assign a first unique identifier to the first post object;
d) correlate the user-selected first category identifier with a first category identifier database;
e) correlating the user-defined second category identifier with a second category identifier database; and
f) populate a first data structure with the user-selected first category identifier, the user-defined second category identifier, and the first unique identifier of the first post object for storage in a database of the apparatus, and later retrieval from the database.
